(19) United States
(12) Patent Application Publication
(10) Pub. No.: US 2009/0127074 A1
(43) Pub. Date: May 21, 2009

(54) Conveying device comprising at least one slide for piece goods, and method for stacking piece goods in a container

(76) Inventors: Alessandro Cavallo, Bernareggio (IT); Daniele Di Benedetto, Cavenago di Brianza (IT); Giuseppe Fabiano, Monza (IT); Carlo Gallizia, Milano (IT); Walter Rosenbaum, Paris (FR); Torsten Tanz, Hilzingen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/918,299

(22) PCT Filed: Mar. 17, 2006
(86) PCT No.: PCT/EP2006/002462

§ 371 Date: Dec. 10, 2008

(30) Foreign Application Priority Data
Apr. 11, 2005 (DE) 10 2005 016 726.8

(51) Int. Cl. B65G 13/06; B65G 37/00; B65G 47/00

(52) U.S. Cl. 198/617; 198/624; 198/784

(57) ABSTRACT

The invention comprises a conveying device for mail piece goods, and a method for the automatic oriented placement of such piece goods in a container. The piece goods are discharged individually into the container via a slide. The slide is has two rolls in the region of the lower planar section of the conveying area. The rolls are power-operated at speeds that are different from each other, have a great section of the conveying area. The rolls are power-operated at speeds that are different from each other, have a great coefficient of friction on the surface thereof, and provide the piece goods with a defined speed in order for the piece goods to be dropped into the container in a targeted manner, be oriented properly, and be stacked. The closer one roll lies to the discharge end, the greater the speed of said roll is selected relative to another roll.

### CROSS REFERENCE TO RELATED APPLICATIONS

This application is the US National Stage of International Application No. PCT/EP2006/002462, filed Mar. 17, 2006 and claims the benefit thereof. The International Application claims the benefits of German application No. 10 2005 016 726.8 filed Apr. 11, 2005, both of the applications are incorporated by reference herein in their entirety.

### FIELD OF INVENTION

The present invention relates to the field of piece good handling (material handling), mail processing and, in particular, to a device and to a method for more efficiently processing combined streams of mail pieces comprising large letters and bulky articles placed into an envelope, and in addition, the full range of small parcels, bundles and packages. The present invention is aimed at the receipt of any desired mail pieces which are caused by the operation to be placed into containers, such as, for example, tubs, trays or baskets in order to facilitate, for example, subsequent multiple sorting operations or transportation. The invention achieves, for a wide range of flat objects and mail pieces, stable stacking of the mail pieces one above another in a container, with their leading edges being oriented one below another within customary industrial tolerances in order to facilitate automatic re-feeding by means of standardized industrial automatic feed devices into a handling device.

### BACKGROUND OF THE INVENTION

Existing methods for sorting such mail pieces on piece good sorting machines, such as, for example, tilt tray sorters or, in particular, cross belt sorters are impaired by the fact that, when the mail pieces are dropped by the particular carrier of the sorter at the discharge into a transporting container, they lie in disarray in the container due to be being dropped without control. Such a disorderly stacking or piling up of mail pieces in mail tubs or containers acts counter to the purpose of automatic sorting, the economic efficiency of which is dependent both on frictionless, multi-stage, internal sorting (passing a number at a time through a sorting system) and on a compact transportation volume, i.e. on making as good use as possible of the available loading capacity of the respective container by orderly stacking of the mail pieces.

U.S. Pat. No. 6,323,452 B1 discloses a sorting system which has a line of individual carriages endlessly circulating in a horizontal plane and having tilt trays on which the piece goods (packages and small parcels) which are to be sorted are placed, which piece goods are placed at various locations onto the tilt tray sorter carriers by means of corresponding feed devices and are discharged at selected discharging points in accordance with their sorting destination. These discharging points comprise slides.

DE 43 42 851 C2 describes the construction and the function of a sorting conveyor with tiltable supporting trays in more detail.

EP 0 700 844 B1 discloses a sorting system with a closed, horizontally circulating line of movable carriers which are each designed as cross belt conveyors, the conveying direction of which therefore runs transversely with respect to the conveying direction of the circulating line. The discharging points at which the piece goods to be sorted are optionally discharged are again designed in the form of a slide.

It is generally known that a collecting container can be placed at the end of such a slide, in which container the discharged piece goods can be collected and transported for a subsequent processing operation, for example to a sorting machine.

EP 1 384 693 A1 discloses a slide with a helical transporting surface which has sidewalls essentially perpendicular to the transporting surface.

### SUMMARY OF INVENTION

In order to achieve the object of ensuring that piece goods (in particular mail pieces) are placed and stacked in as orderly a manner as possible in a container and of improving the operation, the invention proposes a conveying device for piece goods with the features mentioned in the claims and a method for automatically placing and stacking piece goods, with the features mentioned in the independent method claim. Advantageous developments of the transporting apparatus according to the invention emerge from the subclaims. The features of the invention can be combined with one another in any desired manner.

One advantage of the present invention is the provision of an apparatus and of a method for more effective handling of, in particular, mail pieces and for achieving high quality stacking and edging of large letters, flat articles (e.g. catalogs, magazines, etc.), special mail pieces and also any other desired types of mail pieces which can be sorted by means of a cross belt or tilt tray sorter.

Poor quality of stacking and a lack of edging would impair the effectiveness when re-feeding, for example into a flat sorter in order to sort flat mail pieces, and, what is more, the sweeping operators would therefore constantly be occupied with pressing flat articles, which are blocking individual containers because they rest, for example, obliquely on a container wall or edge, into the container, so that further piece goods can be stacked therein. The necessity of a sweeper being temporarily occupied with ensuring good use of the container capacity requires a significant additional use of operators in return.

The present invention takes the edging of objects to be sorted into consideration as one of the important criteria for the quality of stacking. Said edging means that mail pieces which are to be fed again into a sorting system via transportation containers are oriented in such a manner that, when placing them onto a feeder bed, the respective bottom edge of the mail piece and, as far as possible, also the leading edge are each suitably oriented in order to be able to easily be picked up by the feeder induction of the sorting system. Poor edging reduces the throughput of the feed device and may result, for example, in double feeds. The present invention provides a slide for the articles to be sorted, the slide having a design which, in particular, ensures that the stacked flat articles in the container also have a high degree of edging.

Operating sequence studies have shown that stacking of the objects with edging, even if said objects are displaced to a certain extent during transportation of the filled container to a following sorting operation, leads to very much better handling than in the case of flat mail pieces which are simply poured in an uncontrolled manner and without edging.

### BRIEF DESCRIPTION OF THE DRAWINGS

The invention is described in more detail below with reference to the exemplary embodiments which are illustrated in the figures:

FIG. 1 to 7 each show, in a perspective view, a transporting device according to the invention,

FIG. 8 shows a schematic illustration of the interaction of the sorting conveyor with a converter which converts the translatory movement of the sorting conveyor into a rotational movement for the rollers.

### DETAILED DESCRIPTION OF INVENTION

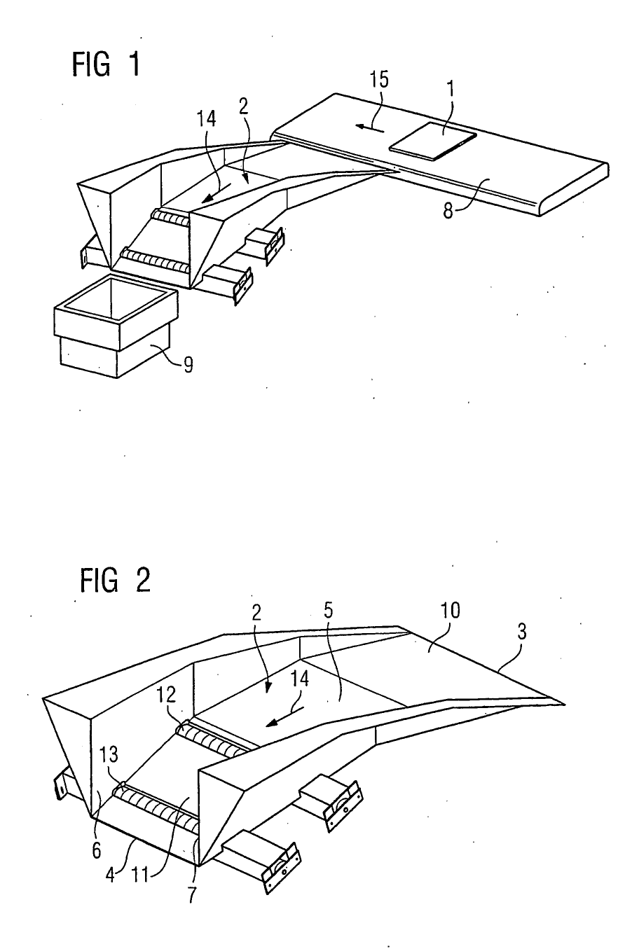

The conveying device according to the invention, illustrated in FIG. 1, for piece goods, in particular for mail pieces, has a feed device 8 which is preferably designed as an electronically controllable cross belt sorter. The movable carrier units (not illustrated specifically) of this cross belt sorter 8 can move, for example horizontally, in a closed circulating process (not illustrated). Of course, it may also involve a sorting section with a defined start and end and/or a tilt tray sorter. The direction of travel of the carriers of the cross belt sorter is denoted by 15. A piece good 1, for example a large letter or a catalog packed in a plastic wrapping or a small parcel, lies on one of the carriers (not illustrated specifically). Said piece good 1 is to be discharged by the cross belt sorter 8 in a targeted manner via a slide 2 with the conveying direction 14 into a container 9 and arranged in said container 9 and deposited with the edges oriented with regard to other mail pieces (not illustrated) possibly already located therein. The slide 2 which is illustrated separately in FIG. 2 plays a crucial part in this.

The slide 2 has an induction end 3 and a discharge end 4 which is located below the latter, which ends are connected to each other via a conveying area 5. The conveying area 5 comprises an upper planar section 10 which is inclined downward, and a lower planar section 11 which is preferably likewise inclined downward. The conveying area 5 is delimited laterally over its entire length by side surfaces 6, 7 which are preferably substantially perpendicular to the conveying area 5. Said side surfaces 6, 7 have the task of conducting the piece goods 1, which are sliding downward over the conveying area 5 to the discharge end 4, to the container 9 in order to be able to receive them in the container 9 in an ordered and oriented manner. In order to ensure the latter, the invention provides, in the lower planar section 11, at least one actuator which, irrespective of the inclination of the slide 2, can influence the conveying speed of the piece good 1 moving on the slide 2.

The speed of the piece good 1 is namely greatly dependent on the weight and the frictional properties of its surface. A relatively heavy object with a very low coefficient of friction (for example with a polyethylene wrapping) slides to the discharge end 4 at a much higher speed than, for example, a flat large letter of low weight with a comparatively rough surface. In principle, an actuator of this type may be designed, for example, even as a braking element which can optionally be pivoted into the conveying plane of the slide 2 as a function of speed and which suitably brakes piece goods which are moving too rapidly. However, the actuator is preferably designed as a driven roller 12, 13 which circulates in the conveying direction and extends from below through a corresponding opening in the conveying area 5 and slightly upward through the latter such that the conveyed piece goods 1 have to come into contact with a subregion of the roller surface. Said roller 12, 13 expediently extends over the entire width of the conveying area 5. It has the task of imparting a defined speed in the conveying direction 14 to the respectively passing piece good 1, i.e. of braking piece goods 1 which are moving too rapidly and of accelerating piece goods 1 which are moving too slowly. In a simplified embodiment of the invention, the roller could, if appropriate, also be designed without its own drive and would then only be capable of acting as braking element. In order to improve the effectiveness of the roller 12, 13 in the influencing of the speed of the piece goods 1, it is recommended to provide the entire or at least parts of the roller surface by a corresponding coating or by the production of a corresponding material with a coefficient of friction which is considerably greater than the coefficient of friction of the conveying area 5. It is particularly advantageous to arrange at least two rollers 12, 13 at a distance from each other in the lower planar section, as is the case in all of the figures. In this case, the rollers 12, 13 of the slide 2 are preferably driven at different speeds from one another instead of at the same speed. It has proven particularly advantageous to set the speed of the upper roller 12 to be lower than that of the lower roller 13 which lies closer to the discharge end 4. This can namely ensure that, even in the event of the piece goods 1 which are dropping into the container 9 following one another very compactly in terms of time, said piece goods are at a sufficient distance from one another as they drop into the container 9 that the piece goods 1 are prevented from disturbing one another, which could adversely affect the orientation of the piece good edges and the satisfactory stacking. Conveying speeds for the upper roller 12 in the range of 0.3-0.7 m/s, in particular of 0.5 m/s, and for the lower roller in the range of 1.0-1.5 m/s, in particular of approximately 1.2 m/s, have proven expedient. The conveying area 5 is expediently also inclined downward in the conveying direction 14 in the lower planar section 11. It may be advantageous in this case to design the inclination of the lower planar section 11 to be greater than that of the upper planar section 10. Within the context of the invention, containers 9 which are essentially rectangular in design are expediently used, as illustrated by way of example in FIGS. 1 and 4-7. It is advantageous here to place a container 9 in each case with one of its longitudinal sides oriented essentially in the same plane in which one of the side surfaces 6 of the lower planar region 11 also lies. This side surface 6 is the side surface to which the arrow for the direction of travel 15 of the sorting conveyor 8 points, i.e. against which a piece good 1 which has been dropped onto the slide 2 by the sorting conveyor 8 will strike on account of its inertia if the transporting speed of the sorting conveyor is just high enough. This assists an orientation of the piece goods 1 which are dropping into the container 9 with one longitudinal edge against this longitudinal side of the container 9. Furthermore, it is advantageous to provide the container 9 with a retaining platform for placing directly following the lower planar section 11, said retaining platform being inclined slightly to the end at which the leading edges of the piece goods 1 should lie (as seen in the conveying direction 14). For example, it is apparent from FIG. 1 that the slide 2, which is arranged essentially transversely to the direction of travel 15 of the sorting conveyor 8, has a slightly curved profile with its conveying area 5 and the side surfaces 6, 7 such that the conveying direction 14 of the slide 2 has, in the vicinity of the induction end 3, a component in the direction of travel 15 of the sorting conveyor 8. Since, in the case of efficient sorting systems, there are relatively high conveying speeds in the direction of travel 15, this mitigates an impact of the dropped-in piece goods 1 against the side surface 6. The dropped-in piece goods 1 can then slide along this side surface 6 downward in the direction of the discharge end 4. The conveying area 5 is expediently designed in such a manner that its width decreases from the induction end 3 to the discharge end 4. This obtains a funnel effect which ensures the orderly transfer of piece goods 1 from the sorting conveyor 8 even at high speeds.

The use of one, two or even more driven rollers 12, 13 at the lower end of the slide 2 has a further advantage. If namely, for example, instead of customary mail transportation containers at the lower end of the slide 2, use is made of very much larger containers 9, for example rolling containers or baskets into which the piece goods 1 are to be discharged, during the filling operation a targeted change in the conveying speed in particular of the lowermost roller 13 can make it possible to change the discharge parabola of the piece goods 1 according to requirements in order to achieve as uniform as possible a distribution of the piece goods 1 over the layout of the rolling container. This is particularly important, for example, during the sorting of packages and small parcels in order to make as extensive use as possible of the loading volume available in such a rolling container without manual interventions in the filling operation being necessary.

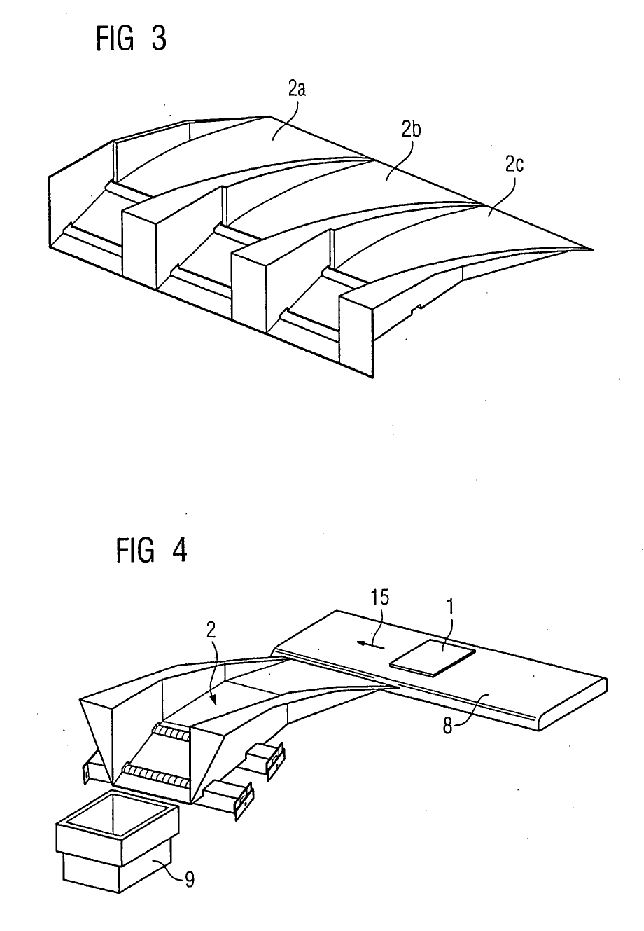

FIG. 3 illustrates a variant of the invention, in which a slide 2 comprising three parallel units 2a, 2b, 2c is used. Each of the three units 2a-2c has, in the lower region, two rollers which are not illustrated directly in FIG. 3 but rather are merely indicated by the corresponding openings in the conveying area 5. In this case, it may be expedient not to provide each of the driven rollers with a separate motor drive but rather to provide just two drives for the entire structural unit of the three slides 2a-2c, i.e. a common drive for all of the lower rollers and another one for all of the upper rollers.

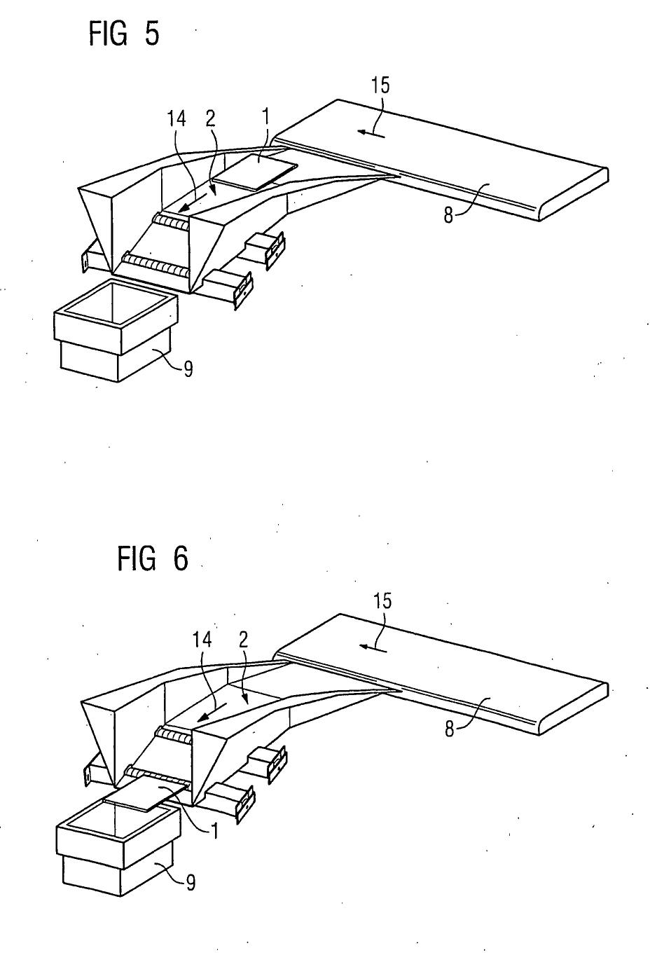

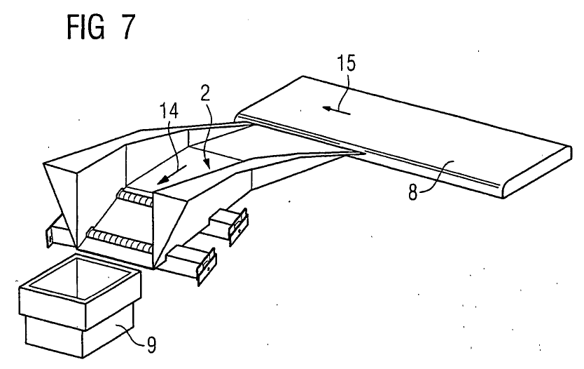

The various stages of conveying a piece good 1 from the sorting conveyor 8 into the container 9 are revealed in detail in FIGS. 4-7. FIG. 4 corresponds to the state from FIG. 1 in which the respective piece good 1 is still located on the carrier of the sorting conveyor 8, which carrier is designed, for example, as a cross belt. As soon as the piece good 1 has come sufficiently close in the direction of travel 15 to the induction end 3 of the slide 2, the cross conveying belt of the cross belt sorter 8 is actuated and the piece good 1 is discharged transversely onto the slide 2 while simultaneously traveling further in the direction of travel 15. In the process, it generally impacts against the side surface 6, as illustrated in FIG. 5. The gradient of the conveying area 5 enables the piece good 1 to slide downward along the side surface 6 and, in the event of too high a sliding speed, is braked by the upper conveying roller 12 to the defined conveying speed of said roller 12. The piece good 1 is then conveyed without interruption to the lower roller 13 which circulates at a higher speed and provides the piece good 1 with this higher speed such that it is discharged, as FIG. 6 shows, at a defined speed and with oriented side edges into the container 9. FIG. 7 shows the end of this individual operation, in which the piece good 1 (no longer visible) is oriented and, with its leading edge bearing against the front end of the container 9, lies on the bottom of the container 9. Further piece goods 1 can then be discharged in the same manner into the container 9 and form an orderly oriented stack of objects which, for a subsequent further sorting operation, can easily be introduced into a corresponding sorting system.

The system according to the invention and the method according to the invention enable in particular flat mail pieces to be very advantageously handled. By means of the preferred use of cross belt sorters, it is possible to control the ejection of the piece goods from the sorting conveyor electronically in an optimum manner such that said mail pieces are conveyed, following gravitational force, by the cross belt conveyor through the upper part of the slide, where the side walls operate as guides and, in the process, absorb the speed component transversely with respect to the conveying direction of the slide during the ejection operation, into the lower part of the slide in an, as it were, channeled manner. The discharge speed is influenced in a targeted manner in the lower part of the slide by the rollers which have a high coefficient of friction at their surface. In this case, the upper roller generally has the task of reducing the initial speed of the respective piece good, and therefore the subsequent, lower roller can provide the piece good with the defined speed required for discharge into the container while a sufficient distance is maintained between consecutive piece goods. This is because, when sorting the mail, a mail sorter frequently presorts the mail pieces in such a manner that a considerable number of, for example, large letters or other flat mail pieces have to pass to the same discharge of the conveying device, the individual mail pieces then passing temporarily directly consecutively onto the same slide. The design according to the invention of the slide then ensures that sufficient distances between the directly consecutive mail pieces are ensured as they pour into the container. The distances of the rollers from one another and from the end of the slide are selected such that the discharge speed can be influenced optimally in the desired manner. The driving of the rollers, which are spaced apart from one another, at different conveying speeds assists a rotation of the conveyed piece goods that is necessary, for example, for correct orientation of their edges with respect to the particular container into which they are to be discharged. The fillable containers according to the invention may be large or small and of any desired type, for example baskets, tubs, trays, crates or rolling containers.

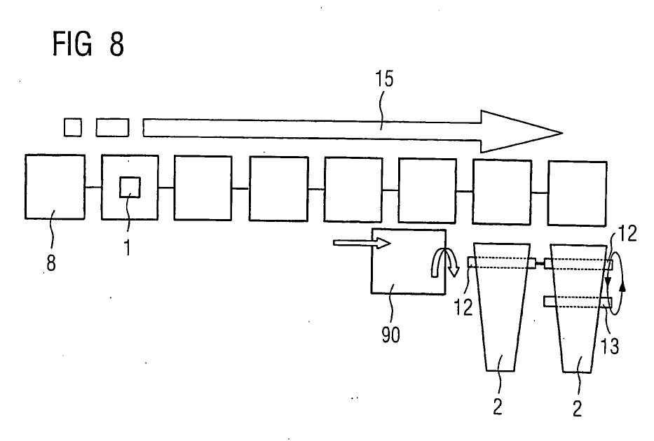

FIG. 8 shows, in a schematic illustration, how a converter 90 taps off part 91 of the translatory movement of the sorting conveyor 8 in the direction of travel 15 and converts it into a rotational movement 92, the rotational movement 92 being transmitted to rollers 12, 13 of slides 2. In this manner, no separate drives are required for the rollers 12, 13 and also a separate activation is not imperative. Driven by the sorting conveyor 8, the converter 90 can drive the rollers 12, 13 of a plurality of slides 2, said rollers being coupled cinematically to one another.

1.-17. (canceled)

18. A conveying device for mail pieces, comprising:
a slide having an induction end and a discharge end arranged below the induction end;
a conveying area having:
a plurality of side surfaces that delimit the conveying area and guide the mail pieces, wherein the conveying area is formed from
an upper planar section that is inclined downward in the conveying direction of the slide, and
a lower planar section, and
a feed device arranged at the induction end, and
an exchangeable receiving container arranged at the discharge end to receive the mail pieces; and
a plurality of rollers that run transversely with respect to a conveying direction of the slide and are driven in the conveying direction, where
the rollers are arranged at a distance from each other in the lower planar section and which protrude from below upward through corresponding openings in the conveying area out of the conveying area, and
the rollers are driven at different speeds from each other such that the speed of an individual roller is set to be greater than a preceding roller speed the closer one roller lies to the discharge end.

19. The conveying device as claimed in claim 18, wherein the rollers are provided, at least in subregions, with a surface which has a substantially higher coefficient of friction in comparison to the conveying area and can be brought into contact with the conveyed piece goods.

20. The conveying device as claimed in claim 18, wherein two rollers are provided, of which the roller further away from the discharge end has a conveying speed in the range of 0.3-0.7 m/s, and the other roller has a conveying speed in the range from 1-1.5 m/s.

21. The conveying device as claimed in claim 18, wherein the roller further away from the discharge end has a conveying speed of 0.5 m/s, and the other roller has a conveying speed of 1.2 m/s.

22. The conveying device as claimed in claim 20, wherein the conveying area is inclined downward in the conveying direction in the lower planar section.

23. The conveying device as claimed in claim 22, wherein the inclination of the lower planar section is greater than the inclination of the upper planar section.

24. The conveying device as claimed in claim 23, wherein the side surfaces are essentially perpendicular to the conveying area.

25. The conveying device as claimed in claim 24, wherein an essentially rectangular in top view container is positioned with one of the longitudinal sides of the container oriented essentially in the same plane as one of the side surfaces of the lower planar region.

26. The conveying device as claimed in claim 25, wherein the respective container is deposited directly following the lower planar section on a retaining platform in a position which is slightly inclined to the end at which the leading edges of the piece goods are located.

27. The conveying device as claimed in claim 26, wherein the width of the conveying area decreases from the induction end to the discharge end.

28. The conveying device as claimed in claim 27, wherein a plurality of slides are arranged directly next to one another to form a group of slides which forms a structural unit.

29. The conveying device as claimed in claim 28, wherein a plurality of rollers corresponding to one group of slides each have a common motor drive.

30. The conveying device as claimed in claim 29, wherein the conveying speed of a roller located closest to the discharge end is varied in a targeted manner during operation to provide a particular piece good passing the discharge end with a desired speed so as to influence its later position in the container.

31. The conveying device as claimed in claim 30, wherein a converter is coupled to the conveying movement of the feed device and drives a roller of a slide, the converter converting the movement of the feed device into a rotational movement of the roller.

32. The conveying device as claimed in claim 31, wherein the converter converts the translatory conveying movement of the feed device into a rotational movement of the rollers.

33. The conveying device as claimed in claim 32, wherein the converter drives a plurality of rollers of a slide.

34. The conveying device as claimed in claim 33, wherein the converter drives rollers of a plurality of slides.

35. The conveying device as claimed in claim 18, wherein the mail pieces are large letters, flat packets, small parcels and packages.

36. A method for automatically placing and stacking mail pieces in a container where the mail pieces are discharged from a material-handing piece good sorting system via a slide and fed to the container, comprising:
providing a slide having a slide wall and an upper and lower slide portion where the lower slide portion is below the upper slide portion, wherein the slide;
arranging a plurality of rollers that run transverse to a conveying direction of the slide such that the rollers protrude from below through corresponding openings in a conveying area of the slide upwards out of the conveying area are driven in the conveying direction, and are arranged at a distance from one another in the lower planar section; and
driving the rollers at different speeds from one another with the closer a particular roller lies to a discharge end of the slide, the greater the speed of the roller to influence the transporting speed of the mail pieces such that the respective mail piece drops into the container at a predetermined speed, upon which the mail pieces are stacked in the container in a manner such that they are oriented one above another.

37. The method as claimed in claim 36, wherein the mail pieces are oriented with respect to a leading and/or longitudinal edge of the mail piece.
